(19) United States
(12) Patent Application Publication
(10) Pub. No.: US 2013/0262991 A1
(43) Pub. Date: Oct. 3, 2013

(54) SYSTEM FOR ADDING CONTENT TO PREFORMATTED DOCUMENTS

(71) Applicants: Timothy F. Donahue, (US); Leonard R. Christopher, Palmyra, NY (US)

(72) Inventors: Timothy F. Donahue, (US); Leonard R. Christopher, Palmyra, NY (US)

(21) Appl. No.: 13/433,339

(22) Filed: Mar. 29, 2012

(51) Int. Cl. G06F 17/00

(52) U.S. Cl. 715/252

(57) ABSTRACT

A system for incorporating additional information into preformatted documents includes a database containing data comprising the preformatted document; retrieving the preformatted document data from the database; a computer for analyzing the preformatted document data and creating additional whitespace outside pre-existing boundaries of the preformatted document data without changing composition of the preformatted document; and inserting the additional information into the whitespace.

### CROSS REFERENCE TO RELATED APPLICATIONS

Reference is made to commonly-assigned copending U.S. patent application Ser. No. ______ (Attorney Docket No. 96695US01NAB), filed herewith, entitled METHOD FOR ADDING CONTENT TO PREFORMATTED DOCUMENTS, by Donahue et al.; the disclosure of which is incorporated herein.

### FIELD OF THE INVENTION

This application relates in general to incorporating additional information into preformatted documents and in particular creating additional whitespace outside pre-existing boundaries of the preformatted document.

### BACKGROUND OF THE INVENTION

In transactional printing a set of commonly formatted personalized documents, each targeting a different mail recipient, is generated. Each document has a format and informational page content that is specific to an intended recipient. In practice, such targeted transactional documents are generated from a carefully designed document template known as a form. Other data such as database driven variable content generation rules, graphical content such as company logos, and various databases are used in conjunction with the form as input to a document composition processor.

The document composition engine uses this data in the generation of a set of transactional documents represented as a sequence of composed graphical pages to be printed, finished and mailed to their various target recipients. The format of each graphical page entry of each transactional document of the content to be printed is encoded in a page definition language format such as AFP, IPDS, Adobe PostScript, PPML, Adobe PDF, and ISO PDF/VT.

Given the kind of personal and business information conveyed in a transactional document, including such things as billing information and printed convenience checks, various security safeguards are typically implemented throughout the print manufacturing process and in some cases the mail delivery process. Such safeguards include verification of the generation of each page of each transactional document, printing of each page of each document, finishing of each document, enveloping and mail distribution. In most all cases of transactional printing the intended output must be guaranteed as having been manufactured and mailed to its target recipient and audit information must be provided as proof.

In many cases, aspects of the form design must incorporate features related to the auditing safeguards used during the print production, finishing, and mail fulfillment. These requirements, along with the need to clearly communicate the personal transactional information to the target recipient, place a significant burden on the form design. As most transactional documents are routinely generated, such as a monthly utility bill, the form design remains constant from month to month so as to minimize the risk in confusing the customer in their interpretation of the transactional information presented.

A recent practice in transactional printing is to add supplemental graphical content to one or more of the various pages comprising each transactional document. Such graphical content may be an advertisement or a coupon that might be of general interest to the target recipient. Adding such an advertisement to a transactional document serves to increase the value of the transactional document as it may lead to a sales opportunity for the advertiser.

Though adding custom promotional advertisements to a transactional document may serve to increase their overall value, adding such content intrusively to an existing transactional document form is often difficult and costly as it requires a redesign of a standard form which is optimized to manufacturing safe guard standards and its fundamental informational layout of familiarity to the end recipient.

There exists a need for a means by which advertisement content can be added to the pages of a transactional document without the need to neither revise the original form design nor change the way the transactional information is presented to the target recipient.

### SUMMARY OF THE INVENTION

Briefly, according to one aspect of the present invention a system for incorporating additional information into preformatted documents includes a database containing data comprising the preformatted document; retrieving the preformatted document data from the database; a computer for analyzing the preformatted document data and creating additional whitespace outside pre-existing boundaries of the preformatted document data without changing composition of the preformatted document; and inserting the additional information into the whitespace.

To accomplish this, an additional process is inserted between the transactional document generation process and the print manufacturing workflow that scans the stream of document and page PDL data. During scanning, the process identifies document break boundaries and the one or more pages of the transactional documents. Of the pages of a transactional document, one or more specific target pages are identified to carry a static marketing message or a dynamic marketing message either by their document page index, or by specific content or metadata present in the page definition. These identified pages are the pages that will receive an imprinted advertisement. Also identified is information that identifies the recipient such as a recipient ID. The recipient ID, for example, might be used by the process to identify a record of a database that provides detailed demographic information about the target recipient. Based on a set of predefined database mapping rules, graphical content representing a personalized marketing message or coupon is generated or a predefined offer or advertisement is selected. The graphical content element representing the advertisement is then merged as content into the pages selected for imprinted content where the content is added to a location of the page that is outside the area of its form content.

If the area of the form content already completely covers that of the intended finished page size, then the processor shall adjust the size of the target page size in a direction that is best accommodated by the established configuration of the print manufacturing system, and a larger page size that accommodates the additional promotional page content is used. Another technique is to dynamically adjust the size the form and its content to create additional white space on the intended finished page size, into which advertisement/messaging content can be dynamically added.

The invention and its objects and advantages will become more apparent in the detailed description of the preferred embodiment presented below.

### BRIEF DESCRIPTION OF THE DRAWINGS

FIG. 1 is a schematic view of a preformatted document.

FIG. 2a is a schematic view of a preformatted document with additional whitespace created by scaling the preformatted content.

FIG. 2b is a schematic view of a preformatted document with additional whitespace created by enlarging the sheet size and shifting the preformatted content.

FIG. 3 is a schematic of the workflow process used to prepare a preformatted document.

FIG. 4 is a schematic of the workflow process used to prepare a preformatted document with additional whitespace.

FIG. 5 is a flowchart for preparing a preformatted document with additional whitespace with additional information inserted.

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

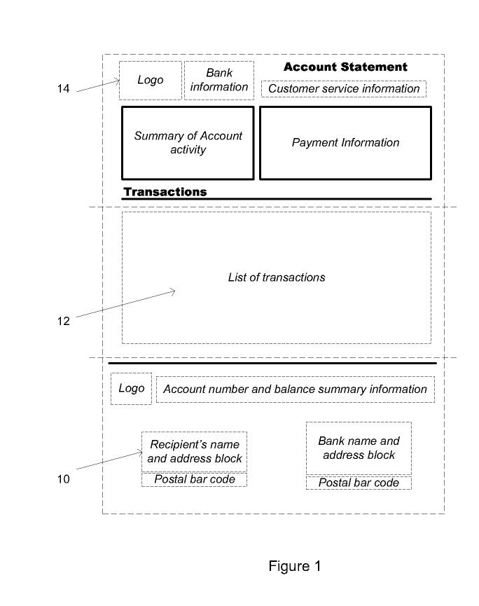

Referring now to FIG. 1 a preformatted document is represented as a transactional statement comprised of various elements such as name, address 10, monthly transactions 12, logos 14, etc. placed on the page related to the purpose of the document. The ability to change elements on this page to incorporate additional information or change format often results in significant time and effort to ensure accuracy and gain organizational approvals. This in turn limits the ease by which new elements can be added to the contents. These new elements may relate to announcements, promotions keyed to the recipient or their geography and third party advertisements commonly incorporated as separate inserts in a distribution process.

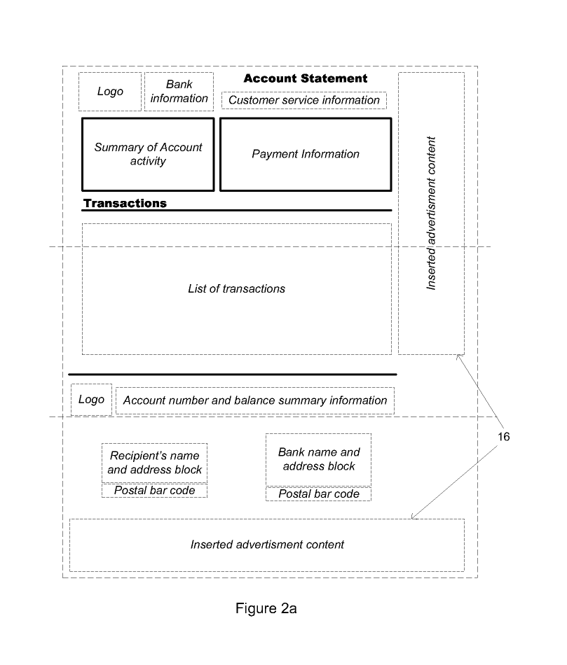

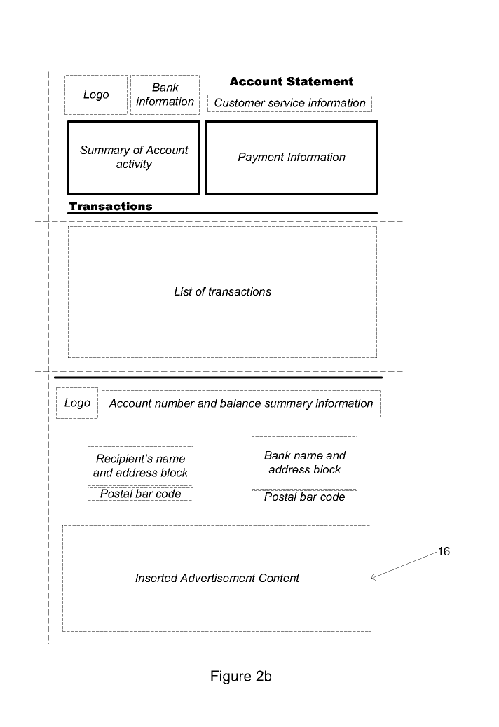

In FIG. 2a, this preformatted document has been scaled down in size to incorporate additional space on the page that may be used for advertisements 16 or other types of communications that are introduced into the data stream prior to printing. In FIG. 2b, the preformatted document is not scaled but instead printed on a larger sheet, such as a legal size sheet, and is shifted to the top or bottom of the physical sheet by the printing system. The additional space on the sheet can then be used for insertion of advertisements 16 or other types of communications.

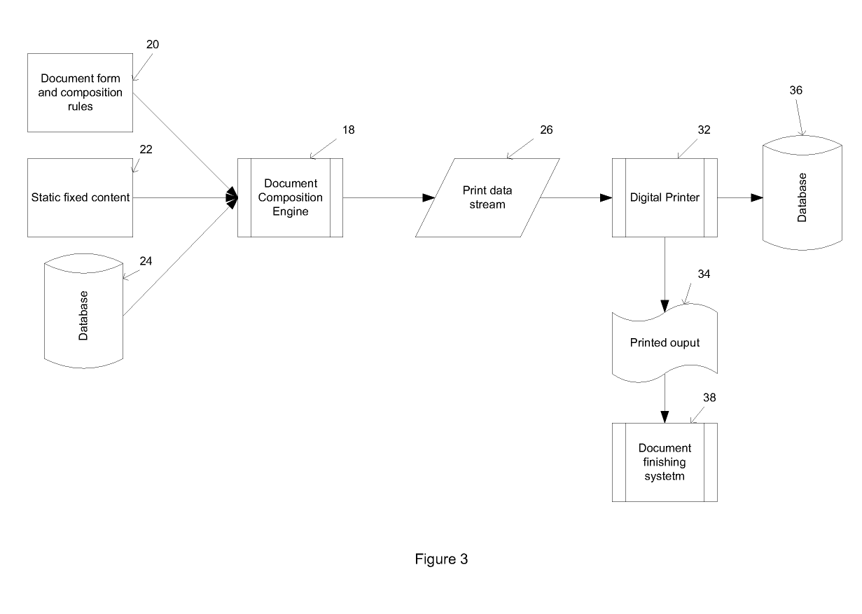

The current process is illustrated in FIG. 3. A document format is created in a composition engine 18 that outlines the form and composition rules 20 with areas for static fixed content 22 as well as areas for variable data from one or more databases 24 that is introduced in the formatting process from one or more databases located on one or more storage devices. The composition engine utilizes the document form and associated composition rules 20 to create an output data stream 26 that is comprised of merged information between static fixed content 22 and variable data from databases 24. This data stream can then be sent to a digital printer 32 for printing 24 or other devices for storage 36 and/or softcopy viewing. The resulting printed document is then sent on to a document finishing system 38 where inserts may be combined into a single letter or parcel.

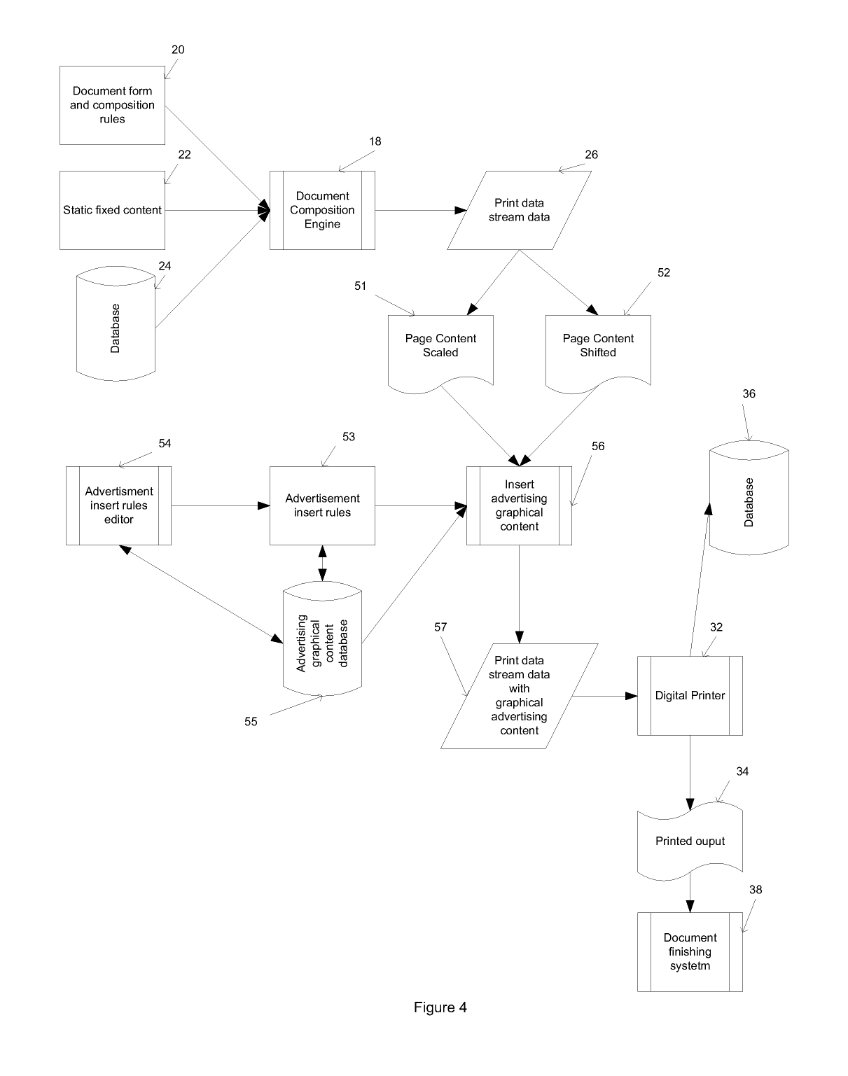

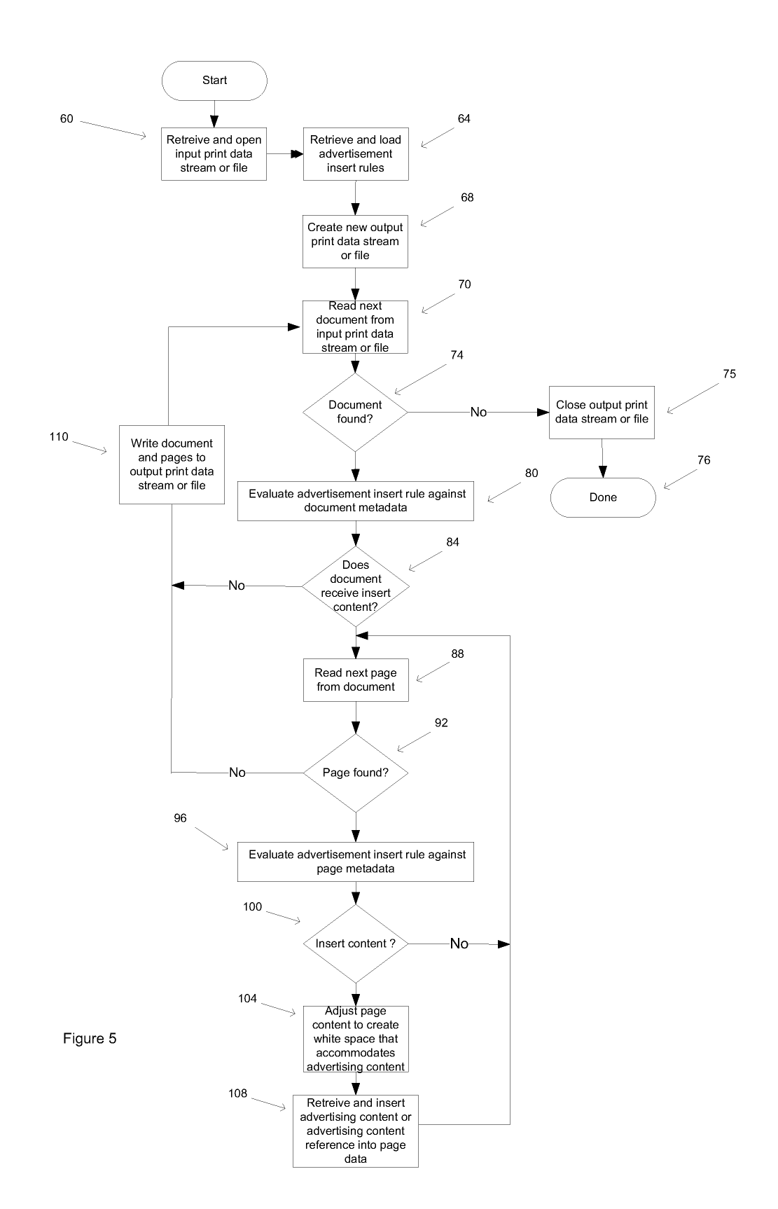

The new process is illustrated in FIG. 4. Like the current process, the format and composition process 18, 20, 22, 24 remains the same through the process of generating the print data stream data 26. The new process then inputs the print data stream data into a series of steps as follows:
1) The preformatted data is either scaled down 51 or shifted on a larger page 52 as illustrated in FIGS. 2a and 2b.
2) The process then executes a lookup for rules 53 related to the data found in the preformatted data stream data for a particular page. These rules may be related to which advertisement data is inserted into the white space created by step 1 above, and may be based on postal sort code or any other unique identifier the system is told to analyze in the print data stream data by an advertisement insert rules editor 54. This process allows information from both alphanumeric as well as graphical images to be inserted into the space created in step 1. This information may be contained and accessed from one or more storage devices and databases 55 accessible by the processor.
3) The new content 55 incorporated in step 2 is merged with the preformatted content modified 51, 52 in step 1 to form a merged print data stream file 57 and is then sent to a digital printer or print ready file 32 for production of printed output 34, and the next page of preformatted data 51, 52 is input as described in step 1 until all pages have been processed as shown in FIG. 5.
4) The printed output generated from step 3 can then be sent to a document finishing system 38 for insertion into envelopes or other containers for distribution.

The flowchart of FIG. 5 describes the program logic for the insert advertising graphical content process 56 that performs the merging of advertising content 55 into the composed input print data stream 26 using the advertising insert rules 53 and generates an output print data stream 57. The program begins by retrieving and opening 60 the input print data stream file 26 created by the document composition engine 18. The program then retrieves and loads 64 the advertisement insert rules 53 and stores them in the memory of the computer. The advertisement insert rules are used in determining whether or not document pages will receive insert content in 80 and 96. A new output print data stream or file 57 is created 68 which is the data stream or file into which all documents and pages will be written 110 in sequence including those with inserted advertising content. From the input data stream or file the next document is read 70. If no document is found then the output print file or stream is closed 75 and processing is done 76. If a next document is found 74, then metadata, such as recipient ID, present in the document is evaluated against advertisement insert rules 80 to decide 84 whether or not the document is a candidate to have advertisement content inserted into one or more of its pages. If it is determined that the document is to receive advertising content, then the next page of the document is read 88. If no document pages are left to read for the current document 92 then the end of input document has been reached and the current output document and pages including revised pages are written to the output print stream or file 110. If a page of the current document is found 92, then page metadata, such as page number or recipient specific information present in the document is evaluated against advertisement insert rules 96 to decide 100 whether or not the page is a candidate to have advertisement content inserted into one or more of its pages. If it is determined that the document page is to be updated to include advertising content, the page content is adjusted to create whitespace 104 into which the advertising content is inserted into the page content based on the advertising insert rule 108.

The invention has been described in detail with particular reference to certain preferred embodiments thereof, but it will be understood that variations and modifications can be effected within the scope of the invention.

### PARTS LIST

10 address
12 transactions
14 logo
16 advertisement
18 composition engine
20 composition rules
22 static fixed content
24 database
26 output data stream
32 digital printer
34 printed output
36 storage
38 document finishing system
51 page content scaled
52 page content shifted
53 advertising insert rules
54 advertisement insert rules editor
55 database
56 graphical content process
57 merged print data stream file
60 retrieve and open file
64 retrieve and load rules
68 create new output print data stream
70 read next document
74 next document found
75 close output print data stream
76 processing done
80 receive insert content
84 decide document receive insert content
88 read next page
92 is page found?
96 receive insert content
100 insert content
104 adjust page to create whitespace
108 advertising insert rule
110 write document and pages to file

1. A system for incorporating additional information into preformatted documents comprising:
a database containing data comprising the preformatted document;
retrieving the preformatted document data from the database;
a computer for analyzing the preformatted document data and creating additional whitespace outside pre-existing boundaries of the preformatted document data without changing composition of the preformatted document; and
inserting the additional information into the whitespace.

2. The system of claim 1 wherein the database is stored on a digital storage device.

3. The system of claim 1 comprising:
a printer for printing the preformatted document with the additional information.

4. The system of claim 1 wherein the preformatted document data includes stylistic elements of the preformatted document.

5. The system of claim 1 wherein the whitespace is created on at least one page of the preformatted document.

6. The system of claim 1 wherein the whitespace is created on every page of the preformatted document.

7. The system of claim 1 comprising:
creating a larger page size than a page size associated with the preformatted document; and
creating the whitespace on unused portions of the larger page.

8. The system of claim 1 comprising:
extracting unique information from the preformatted document; and
selecting the additional information based on the unique information from the preformatted document.

9. The system of claim 1 comprising:
resizing the composition of the preformatted document to create the additional whitespace.

10. The system of claim 1 wherein the additional whitespace is created on a side or top or bottom of the preformatted document.
